(19) United States
(12) Patent Application Publication
(10) Pub. No.: US 2018/0081711 A1
(43) Pub. Date: Mar. 22, 2018

(54) METHOD AND APPARATUS FOR OPERATING SYSTEM LEVEL OF APPLICATION

(71) Applicant: Baidu Online Network Technology (Beijing) Co., Ltd., Beijing (CN)

(72) Inventors: Jingmin Zhang, Beijing (CN); Chong Li, Beijing (CN); Ran Ma, Beijing (CN)

(21) Appl. No.: 15/587,002

(22) Filed: May 4, 2017

(30) Foreign Application Priority Data
Sep. 22, 2016 (CN) 201610844361.3

(51) Int. Cl. G06F 9/48

(52) U.S. Cl. CPC G06F 9/485

(57) ABSTRACT

The present disclosure provides a method and apparatus for operating a system level of an application. In embodiments of the present disclosure, a system level operation instruction is acquired and used to invoke the designated system level interface to operate the designated application so that the designated application is operated according to the system level operation instruction and the process where the application lies is stopped.

Since upon completion of the operation, it is feasible to only execute an operation related to stop of application, namely, stop of the process where the application lies, no longer execute other operations related to stop of application, the acquired auxiliary function permission of the operating system does not disappear. As such, once the auxiliary function permission of the operating system is acquired, the application can permanently have a capability of invoking partial system level interfaces, needless to set the auxiliary function permission of the operating system again and again, thereby improving an efficiency of the system level operation.

### CROSS-REFERENCE TO RELATED APPLICATIONS

This application claims priority to Chinese Application No. 201610844361.3, filed Sep. 22, 2016, which is hereby incorporated by reference in its entirety.

### BACKGROUND

### Field of the Disclosure

The present disclosure relates to the Internet technology, and particularly to a method and apparatus for operating a system level of an application.

### Background of the Disclosure

An application is an application program running on a terminal with an operating system installed. The terminal needs to download an a setup file of the application, for example, Android Packet Kit (APK) file, and run the setup file of the application in the operating system to install the application. After the application is successfully installed can the application run in the terminal normally to provide service of the application. Usually, in the operating system there exist interfaces at different levels, namely, system level interface and ordinary level interface which are to be invoked by an application with a corresponding permission. Specifically, an application having a system permission may invoke the system level interface and ordinary level interface, whereas an application not having the system permission can only invoke the ordinary level interface. To enable the application not having the system permission to invoke partial system level interfaces, it is feasible to set a corresponding auxiliary function permission of the operating system for the application not having the system permission to invoke partial system level interfaces and complete system level operation of the designated application, for example, compulsorily stop the designated application which is running.

However, in some cases, an application might be stopped, i.e., a process where the application lies is stopped and the auxiliary function permission of the operating system acquired by the application is cancelled, for example, other applications invoke a designated system level interface. The application is stopped so that the auxiliary function permission of the operating system acquired by the application also disappears.

It is necessary to re-set the auxiliary function permission of the operating system to invoke partial system level interfaces and complete system level operation of the designated application, thereby causing reduction of an efficiency of the system level operation.

### SUMMARY OF THE DISCLOSURE

A plurality of aspects of the present disclosure provide a method and apparatus for operating a system level of an application, to improve an efficiency of the system level operation.

According to an aspect of the present disclosure, there is provided a method for operating a system level of an application, comprising:

acquiring a system level operation instruction which is used to invoke a designated system level interface to operate a designated application;

operating the designated application according to the system level operation instruction;

stopping a process where the application lies

The above aspect and any possible implementation mode further provide an implementation mode: the system level operation instruction comprises a compulsory stop instruction.

The above aspect and any possible implementation mode further provide an implementation mode: the acquiring a system level operation instruction comprises:

acquiring the system level operation instruction which is triggered by the user by operating a designated control of the application to which the execution subject belongs; or

acquiring the system level operation instruction coming from an external application.

The above aspect and any possible implementation mode further provide an implementation mode: before operating the designated application according to the system level operation instruction, the method further comprises:

acquiring an auxiliary function permission of the operating system of the terminal to execute the system level operation instruction.

The above aspect and any possible implementation mode further provide an implementation mode: the stopping a process where the application lies comprises:

stopping the process where the application lies, if the operation for the designated application is completed; or

stopping the process where the application lies, if running at the foreground of the operating system of the terminal is switched to the running at the background of the operating system.

The above aspect and any possible implementation mode further provide an implementation mode: before acquiring the system level operation instruction, or at the is same time, the method further comprises: activating the process where the application lies.

According to another aspect of the present disclosure, there is provided an apparatus for operating a system level of an application, comprising:

an acquiring unit configured to acquire a system level operation instruction which is used to invoke a designated system level interface to operate a designated application;

an instructing unit configured to operate the designated application according to the system level operation instruction;

an executing unit configured to stop a process where the application lies.

The above aspect and any possible implementation mode further provide an implementation mode: the system level operation instruction comprises a compulsory stop instruction.

The above aspect and any possible implementation mode further provide an implementation mode: the acquiring unit is specifically configured to:

acquire the system level operation instruction which is triggered by the user by operating a designated control of the application to which the execution subject belongs; or

acquire the system level operation instruction coming from an external application.

The above aspect and any possible implementation mode further provide an implementation mode: the instructing unit is further configured to:

acquire an auxiliary function permission of the operating system of the terminal to execute the system level operation instruction.

The above aspect and any possible implementation mode further provide an implementation mode: the executing unit is specifically configured to:

stop the process where the application lies, if the operation for the designated application is completed; or

stop the process where the application lies, if running at the foreground of the operating system of the terminal is switched to the running at the background of the is operating system.

The above aspect and any possible implementation mode further provide an implementation mode: the acquiring unit is further configured to activate the process where the application lies.

As known from the above technical solutions, in embodiments of the present disclosure, the system level operation instruction is acquired and used to invoke the designated system level interface to operate the designated application so that the designated application is operated according to the system level operation instruction and the process where the application lies is stopped. Since upon completion of the operation, it is feasible to only execute an operation related to stop of application, namely, stop of the process where the application lies, no longer execute other operations related to stop of application, the acquired auxiliary function permission of the operating system does not disappear. As such, once the auxiliary function permission of the operating system is acquired, the application can permanently have a capability of invoking partial system level interfaces, needless to set the auxiliary function permission of the operating system again and again, thereby improving an efficiency of the system level operation.

In addition, with the technical solutions provided by the present disclosure being employed, since it is unnecessary to set the auxiliary function permission of the operating system again and again, once the auxiliary function permission of the operating system is obtained, manual participation is not needed. The operation is simple, and the efficiency of the system level operation can be further improved.

In addition, the user's experience can be substantially boosted by employing the technical solutions provided by the present disclosure.

### BRIEF DESCRIPTION OF DRAWINGS

To describe technical solutions of embodiments of the present disclosure more clearly, figures to be used in the embodiments or in depictions regarding the prior art will be described briefly. Obviously, the figures described below are only some embodiments of the present disclosure. Those having ordinary skill in the art appreciate that other figures may be obtained from these figures without making inventive efforts.

FIG. 1 is a flow chart of a method of operating a system level of an application according to an embodiment of the present disclosure;

FIG. 2 is a block diagram of an apparatus for operating a system level of an application according to an embodiment of the present disclosure.

### DETAILED DESCRIPTION OF PREFERRED EMBODIMENTS

To make objectives, technical solutions and advantages of embodiments of the present disclosure clearer, technical solutions of embodiment of the present disclosure will be described clearly and completely with reference to figures in embodiments of the present disclosure. Obviously, embodiments described here are partial embodiments of the present disclosure, not all embodiments. All other embodiments obtained by those having ordinary skill in the art based on the embodiments of the present disclosure, without making any inventive efforts, fall within the protection scope of the present disclosure.

It needs to be appreciated that the terminals involved in the embodiments of the present disclosure comprise but are not limited to a mobile phone, a Personal Digital Assistant (PDA), a wireless handheld device, a tablet computer, a Personal Computer (PC), an MP3 player, an MP4 player, and a wearable device (e.g., a pair of smart glasses, a smart watch, or a smart bracelet).

In addition, the term “and/or” used in the text is only an association relationship depicting associated objects and represents that three relations might exist, for example, A and/or B may represents three cases, namely, A exists individually, both A and B coexist, and B exists individually. In addition, the symbol “/” in the text generally indicates associated objects before and after the symbol are in an “or” relationship.

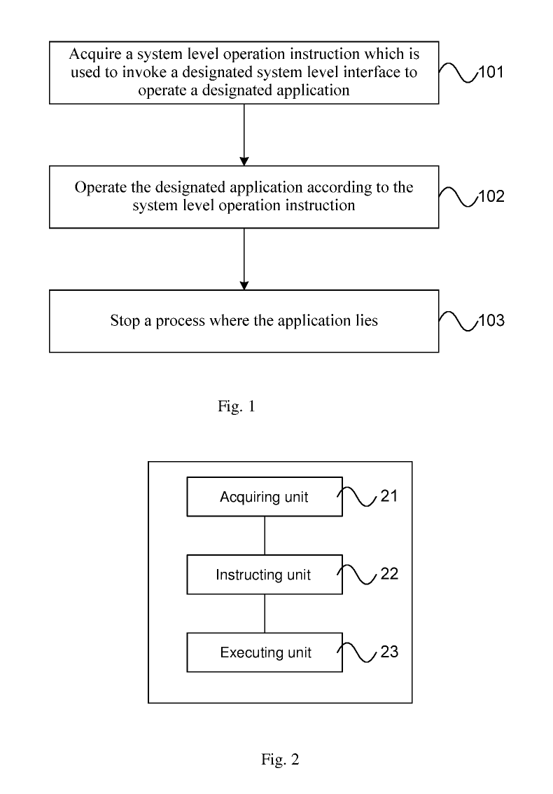

FIG. 1 is a flow chart of a method of operating a system level of an application according to an embodiment of the present disclosure.

101: acquiring a system level operation instruction which is used to invoke a designated system level interface to operate a designated application.

The so-called system level operation instruction refers to an operation instruction for invoking a designated system level interface to operate the designated application.

For example, a compulsory stop instruction is used to simulatively click a compulsory stop control provided by the operating system to stop the designated application, namely, stop a process where the application lies and cancel the auxiliary function permission of the operating system acquired by the application.

102: operating the designated application according to the system level operation instruction.

103: stopping the process where the application lies.

It needs to be appreciated that all or part of a subject for executing 101-103 may be an application located at a local terminal, or a function unit such as a plug-in or Software Development Kit (SDK) located in an application located at the local terminal. This is not particularly limited in the present embodiment.

It may be understood that the application may be a native application (nativeAPP) installed on the terminal, or a web application (webAPP) of a browser on the terminal. This is not particularly limited in the present embodiment.

As such, a system level operation instruction which is used to invoke a designated system level interface is acquired to operate a designated application so that the designated application is operated according to the system level operation instruction and the process where the application lies is stopped. Since upon completion of the operation, it is feasible to only execute an operation related to stop of application, namely, stop of the process where the application lies, no longer execute other operations related to stop of application, the acquired auxiliary function permission of the operating system does not disappear. As such, once the auxiliary function permission of the operating system is acquired, the application can permanently have a capability of invoking partial system level interfaces, needless to set the auxiliary function permission of the operating system again and again, thereby improving an efficiency of the system level operation.

In the present disclosure, an application to which the execution subject belongs may be an application pre-installed in the terminal before the terminal is delivered out of the factory, or may be an application installed in the terminal after the terminal acquires a setup file of the application from a distribution platform. This is not particularly limited in the present embodiment.

Optionally, in a possible implementation mode of the present embodiment, in 101, it is specifically feasible to acquire the system level operation instruction which is triggered by the user by operating a designated control of the application to which the execution subject belongs.

In this implementation mode, the application to which the execution subject belongs may provide the user with a designated control to be operated by the user to thereby trigger the system level operation instruction.

During operation, the application to which the execution subject belongs may consider by default the user's operation objects as all applications, for example, all applications in the terminal or all applications running in the terminal and the like, or may further provide the user with more personalized options to determine the operation object, for example, operate all applications, operate the selected application and the like. This is not particularly limited in the present embodiment.

Optionally, in a possible implementation mode of the present embodiment, in 101, it is specifically feasible to acquire the system level operation instruction coming from an external application.

In this implementation mode, the external application is another application separate from the application to which the execution subject belongs, and may specifically provide the user with a designated control to be operated by the user to thereby trigger the system level operation instruction.

During operation, the external application may consider by default the user's operation objects as all applications, for example, all applications in the terminal or all applications running in the terminal and the like, or may further provide the user with more personalized options to determine the operation object, for example, operate all applications, operate the selected application and the like. This is not particularly limited in the present embodiment.

Optionally, in a possible implementation mode of the present embodiment, before 102, it is feasible to further acquire the auxiliary function permission of the operating system of the terminal to execute the system level operation instruction.

In a specific implementation procedure, the obtained auxiliary function permission of is the operating system may be set by the user through a designated page of the operating system.

In another specific implementation procedure, the obtained auxiliary function permission of the operating system may be set by the user through a designated page of the application to which the execution subject belongs.

Optionally, in a possible implementation mode of the present embodiment, in 103, specifically it is feasible to immediately stop the process where the application lies, if the operation for the designated application is completed.

Optionally, in a possible implementation mode of the present embodiment, in 103, specifically it is feasible to immediately stop the process where the application lies, if running at the foreground of the operating system of the terminal is switched to the running at the background of the operating system. At this time, the process to which the application lies is immediately stopped no matter whether the operation for the designated application is completed or not. As such, this can prevent the application to which the execution subject belongs from being stopped by other applications, namely, the following can be avoided: the process where the application lies is stopped and the auxiliary function permission of the operating system acquired by the application is cancelled, so that the auxiliary function permission of the operating system acquired by the application also disappears, and it is necessary to re-set the auxiliary function permission of the operating system to invoke partial system level interfaces and complete system level operation of the designated application.

Optionally, in a possible implementation mode of the present embodiment, before 101, it is feasible to activate the process where the application lies.

In this implementation mode, the user may activate the process where the application lies by operating an icon of the application to which the execution subject belongs, as provided by the terminal. At this time, the user may operate the page provided by the application, find a designated control and thereby operate the designated control, for example, click the designated control. As such, it is feasible to use the activated process to directly acquire the system level operation instruction which is triggered by the user by operating the designated control of the application to which the execution subject is belongs.

Optionally, in a possible implementation mode of the present embodiment, at 101, it is feasible to simultaneously activate the process where the application lies.

In this implementation mode, the user may operate the external application, namely, a page provided by other applications separate from the application to which the execution subject belongs, to find a designated control and thereby operate the designated control, for example, click the designated control. As such, it is feasible to trigger the system level operation instruction. The application to which the execution subject belongs receives the system level operation instruction to activate the process where the application lies.

In this implementation mode, since activation of the process where the application to which the execution subject belongs lies is triggered by the external application, the icon of the application may not be displayed on the terminal.

In the present embodiment, the system level operation instruction is acquired and used to invoke the designated system level interface to operate the designated application so that the designated application is operated according to the system level operation instruction and the process where the application lies is stopped. Since upon completion of the operation, it is feasible to only execute an operation related to stop of application, namely, stop of the process where the application lies, no longer execute other operations related to stop of application, the acquired auxiliary function permission of the operating system does not disappear. As such, once the auxiliary function permission of the operating system is acquired, the application can permanently have a capability of invoking partial system level interfaces, needless to set the auxiliary function permission of the operating system again and again, thereby improving an efficiency of the system level operation.

In addition, with the technical solution provided by the present disclosure being employed, since it is unnecessary to set the auxiliary function permission of the operating system again and again, once the auxiliary function permission of the operating system is obtained, manual participation is not needed. The operation is simple, and the efficiency of the system level operation can be further improved.

In addition, the user's experience can be substantially boosted by employing the technical solution provided by the present disclosure.

As appreciated, for ease of description, the aforesaid method embodiments are all described as a combination of a series of actions, but those skilled in the art should appreciated that the present disclosure is not limited to the described order of actions because some steps may be performed in other orders or simultaneously according to the present disclosure. Secondly, those skilled in the art should appreciate the embodiments described in the description all belong to preferred embodiments, and the involved actions and modules are not necessarily requisite for the present disclosure.

In the above embodiments, different emphasis is placed on respective embodiments, and reference may be made to related depictions in other embodiments for portions not detailed in a certain embodiment.

FIG. 2 is a block diagram of an apparatus for operating a system level of an application according to an embodiment of the present disclosure. As shown in FIG. 2, the apparatus for operating a system level of an application in the present embodiment may comprise an acquiring unit 21, an instructing unit 22 and an executing unit 23, wherein the acquiring unit 21 is configured to acquire a system level operation instruction which is used to invoke a designated system level interface to operate a designated application; the instructing unit 22 is configured to operate the designated application according to the system level operation instruction; the executing unit 23 is configured to stop a process where the application lies.

The so-called system level operation instruction refers to an operation instruction for invoking a designated system level interface to operate the designated application.

For example, a compulsory stop instruction is used to simulatively click a compulsory stop control provided by the operating system to stop the designated application, namely, stop a process where the application lies and cancel the auxiliary function permission of the operating system acquired by the application.

It needs to be appreciated that all or part of the apparatus for operating the system level of the application provided by the present embodiment may be an application located at a local terminal, or a function unit such as a plug-in or Software Development Kit (SDK) located in an application located at the local terminal.

It may be understood that the application may be a native application (nativeAPP) installed on the terminal, or a web application (webAPP) of a browser on the terminal. This is not particularly limited in the present embodiment.

In the present disclosure, an application to which the execution subject belongs may be an application pre-installed in the terminal before the terminal is delivered out of the factory, or may be an application installed in the terminal after the terminal acquires a setup file of the application from a distribution platform. This is not particularly limited in the present embodiment.

Optionally, in a possible implementation mode of the present embodiment, the acquiring unit 21 may specifically be configured to acquire the system level operation instruction which is triggered by the user by operating a designated control of the application to which the execution subject belongs.

Optionally, in a possible implementation mode of the present embodiment, the acquiring unit 21 may specifically be configured to acquire the system level operation instruction coming from an external application.

Optionally, in a possible implementation mode of the present embodiment, the instructing unit 22 may further be configured to acquire the auxiliary function permission of the operating system of the terminal to execute the system level operation instruction.

Optionally, in a possible implementation mode of the present embodiment, the executing unit 23 may specifically be configured to stop the process where the application lies, if the operation for the designated application is completed.

Optionally, in a possible implementation mode of the present embodiment, the executing unit 23 may specifically be configured to stop the process where the application lies, if running at the foreground of the operating system of the terminal is switched to the running at the background of the operating system.

Optionally, in a possible implementation mode of the present embodiment, the acquiring unit 21 may further be configured to activate the process where the application lies.

It needs to be appreciated that the method in the embodiment corresponding to FIG. 1 is may be implemented by the apparatus for operating the system level of the application according to the present embodiment. Reference may be made to relevant content in the embodiment corresponding to FIG. 1 for detailed description, which will not be detailed any longer here.

In the present embodiment, the system level operation instruction is acquired by the acquiring unit and used to invoke the designated system level interface to operate the designated application so that the instructing unit can operate the designated application according to the system level operation instruction and thereby the executing unit stops the process where the application lies. Since upon completion of the operation, it is feasible to only execute an operation related to stop of application, namely, stop of the process where the application lies, no longer execute other operations related to stop of application, the acquired auxiliary function permission of the operating system does not disappear. As such, once the auxiliary function permission of the operating system is acquired, the application can permanently have a capability of invoking partial system level interfaces, needless to set the auxiliary function permission of the operating system again and again, thereby improving an efficiency of the system level operation.

In addition, with the technical solution provided by the present disclosure being employed, since it is unnecessary to set the auxiliary function permission of the operating system again and again, once the auxiliary function permission of the operating system is obtained, manual participation is not needed. The operation is simple, and the efficiency of the system level operation can be further improved.

In addition, the user's experience can be substantially boosted by employing the technical solution provided by the present disclosure.

Those skilled in the art can clearly understand that for purpose of convenience and brevity of depictions, reference may be made to corresponding procedures in the aforesaid method embodiments for specific operation procedures of the system, apparatus and units described above, which will not be detailed any more.

In the embodiments provided by the present disclosure, it should be understood that the revealed system, apparatus and method can be implemented in other ways. For example, the above-described embodiments for the apparatus are only exemplary, e.g., is the division of the units is merely logical one, and, in reality, they can be divided in other ways upon implementation. For example, a plurality of units or components may be combined or integrated into another system, or some features may be neglected or not executed. In addition, mutual coupling or direct coupling or communicative connection as displayed or discussed may be indirect coupling or communicative connection performed via some interfaces, means or units and may be electrical, mechanical or in other forms.

The units described as separate parts may be or may not be physically separated, the parts shown as units may be or may not be physical units, i.e., they can be located in one place, or distributed in a plurality of network units. One can select some or all the units to achieve the purpose of the embodiment according to the actual needs.

Further, in the embodiments of the present disclosure, functional units can be integrated in one processing unit, or they can be separate physical presences; or two or more units can be integrated in one unit. The integrated unit described above can be implemented in the form of hardware, or they can be implemented with hardware plus software functional units.

The aforementioned integrated unit in the form of software function units may be stored in a computer readable storage medium. The aforementioned software function units are stored in a storage medium, including several instructions to instruct a computer device (a personal computer, server, or network equipment, etc.) or processor to perform some steps of the method described in the various embodiments of the present disclosure. The aforementioned storage medium includes various media that may store program codes, such as U disk, removable hard disk, read-only memory (ROM), a random access memory (RAM), magnetic disk, or an optical disk.

Finally, it is appreciated that the above embodiments are only used to illustrate the technical solutions of the present disclosure, not to limit the present disclosure; although the present disclosure is described in detail with reference to the above embodiments, those having ordinary skill in the art should understand that they still can modify technical solutions recited in the aforesaid embodiments or equivalently replace partial technical features therein; these modifications or substitutions do not make essence of corresponding technical solutions depart from the spirit and scope of technical solutions of embodiments of the present disclosure.

1. A method for operating a system level of an application, comprising:
acquiring a system level operation instruction which is used to invoke a designated system level interface to operate a designated application;
operating the designated application according to the system level operation instruction;
stopping a process where the application lies.

2. The method according to claim 1, wherein the system level operation instruction comprises a compulsory stop instruction.

3. The method according to claim 1, wherein the acquiring a system level operation instruction comprises:
acquiring the system level operation instruction which is triggered by the user by operating a designated control of the application to which the execution subject belongs; or
acquiring the system level operation instruction coming from an external application.

4. The method according to claim 1, wherein before operating the designated application according to the system level operation instruction, the method further comprises:
acquiring an auxiliary function permission of the operating system of the terminal to execute the system level operation instruction.

5. The method according to claim 1, wherein the stopping a process where the application lies comprises:
stopping the process where the application lies, if the operation for the designated application is completed; or
stopping the process where the application lies, if running at a foreground of the operating system of the terminal is switched to the running at a background of the operating system.

6. The method according to claim 1, wherein before acquiring the system level operation instruction, or at the same time, the method further comprises:
activating the process where the application lies.

7. An apparatus, comprising:
one or more processor;
a memory;
one or more programs stored in the memory and configured to execute the following operation when executed by the one or more processors:
acquiring a system level operation instruction which is used to invoke a designated system level interface to operate a designated application;
operating the designated application according to the system level operation instruction;
stopping a process where the application lies.

8. The apparatus according to claim 7, wherein the system level operation instruction comprises a compulsory stop instruction.

9. The apparatus according to claim 7, wherein the operation of acquiring a system level operation instruction comprises:
acquiring the system level operation instruction which is triggered by the user by operating a designated control of the application to which the execution subject belongs; or
acquiring the system level operation instruction coming from an external application.

10. The apparatus according to claim 7, wherein before operating the designated application according to the system level operation instruction, the operation further comprises:
acquiring an auxiliary function permission of the operating system of the terminal to execute the system level operation instruction.

11. The apparatus according to claim 7, wherein the operation of stopping a process where the application lies comprises:
stopping the process where the application lies, if the operation for the designated application is completed; or
stopping the process where the application lies, if running at a foreground of the operating system of the terminal is switched to the running at a background of the operating system.

12. The apparatus according to claim 7, wherein before acquiring the system level operation instruction, or at the same time, the operation further comprises:
activating the process where the application lies.

13. A non-volatile computer storage medium in which one or more programs are stored, an apparatus being enabled to execute the following operation when said one or more programs are executed by the apparatus:
acquiring a system level operation instruction which is used to invoke a designated s system level interface to operate a designated application;
operating the designated application according to the system level operation instruction;
stopping a process where the application lies.

14. The non-volatile computer storage medium according to claim 13, wherein the system level operation instruction comprises a compulsory stop instruction.

15. The non-volatile computer storage medium according to claim 13, wherein the operation of acquiring a system level operation instruction comprises:
acquiring the system level operation instruction which is triggered by the user by operating a designated control of the application to which the execution subject belongs; or
acquiring the system level operation instruction coming from an external application.

16. The non-volatile computer storage medium according to claim 13, wherein before operating the designated application according to the system level operation instruction, the operation further comprises:
acquiring an auxiliary function permission of the operating system of the terminal to execute the system level operation instruction.

17. The non-volatile computer storage medium according to claim 13, wherein the operation of stopping a process where the application lies comprises:
stopping the process where the application lies, if the operation for the designated application is completed; or
stopping the process where the application lies, if running at a foreground of the operating system of the terminal is switched to the running at a background of the operating system.

18. The non-volatile computer storage medium according to claim 13, wherein before acquiring the system level operation instruction, or at the same time, the operation further comprises:
activating the process where the application lies.
